(19) United States
(12) Patent Application Publication
(10) Pub. No.: US 2019/0315200 A1
(43) Pub. Date: Oct. 17, 2019

(54) AIR VENT FOR A VEHICLE

(71) Applicant: ILLINOIS TOOL WORKS INC., Glenview, IL (US)

(72) Inventor: Joachim PESTKE, Enkenbach-Alsenborn (DE)

(21) Appl. No.: 16/381,160

(22) Filed: Apr. 11, 2019

(30) Foreign Application Priority Data
Apr. 13, 2018 (DE) 102018108812.4

(51) Int. Cl. B60H 1/34; B60H 1/00

(52) U.S. Cl. CPC B60H 1/3421; B60H 2001/00721; B60H 1/00671

(57) ABSTRACT

An air vent for a vehicle includes a housing with an inlet opening and an outlet opening which is delimited by way of a housing outlet wall, an air duct for an air stream which flows from the inlet opening to the outlet opening being defined between the inlet opening and the outlet opening. Air guiding elements are arranged adjustably in the housing for deflecting the air stream, the air guiding elements including at least two air guiding shells which are mounted in the housing such that they can be moved between a first end position and a second end position in order to deflect the air stream, the at least two air guiding shells being covered by way of the housing outlet wall at least in one position, as viewed counter to the flow direction of the air stream.

### TECHNICAL FIELD

The invention relates to an air vent for a vehicle, with a housing with an inlet opening and an outlet opening which is delimited by way of a housing outlet wall, an air duct for an air stream which flows from the inlet opening to the outlet opening being defined between the inlet opening and the outlet opening, and air guiding elements arranged adjustably in the housing for deflecting the air stream.

### BACKGROUND

By way of air vents of the above-mentioned type, fresh air is fed to the interior compartment of vehicles, such as passenger cars or trucks. To this end, the air vents have a housing with an inlet opening for fresh air. Furthermore, the housing has an outlet opening which faces the vehicle interior compartment. An air duct for air which flows through the air vent and is to be guided into the vehicle interior compartment is formed between the inlet opening and the outlet opening. In the case of known air vents, air guiding elements, such as air guiding slats, are arranged in the housing, in particular the air duct, such that they can be moved, for example can be pivoted, between two end positions. The air stream can be deflected in a desired way by way of adjustment of the air guiding elements.

Air vents are known, for example, from DE 10 2006 032 587 B4, DE 10 2013 209 430 B3, DE 10 2014 101 315 A1 or DE 10 2014 221 641 A1.

One disadvantage of known air vents lies in the fact that the air guiding elements which are arranged in the air duct, such as air guiding slats, restrict the flow cross section which is available for the air. This is the case, in particular, in the region of the end positions of the air guiding elements. Restrictions of the available flow cross section of more than 20% can occur. Moreover, there is in part the desire, for design reasons, to integrate the outlet openings of the air vents into the overall dashboard design harmonically as slot-shaped openings in such a way that the functional elements of the air vents, in particular the slats, cannot be seen directly from the vehicle interior compartment.

### SUMMARY

Proceeding from the described prior art, the invention is based on the object of providing an air vent of the type mentioned at the outset which permits as great a design freedom as possible in the case of a maximized flow cross section for air.

For an air vent of the type which is mentioned at the outset, the invention achieves the object by virtue of the fact that the air guiding elements comprise at least two air guiding shells which are mounted in the housing such that they can be moved between a first end position and a second end position in order to deflect the air stream, the at least two air guiding shells being covered by way of the housing outlet wall at least in one position, as viewed counter to the flow direction of the air stream.

The air vent is used in a vehicle, such as a passenger car or a truck. Fresh air is fed to the inlet opening of the housing, which fresh air passes through the housing to the outlet opening and, via the latter, into the vehicle interior compartment. Air guiding elements which can be adjusted between two end positions are arranged in the housing in a manner known per se, by way of the adjustment of which air guiding elements the air stream which is guided into the vehicle interior compartment can be deflected in a desired way. The outlet opening is delimited by way of a housing outlet wall. It can be formed by way of a bezel of the housing.

According to the invention, at least two air guiding shells are arranged in the housing such that they can be adjusted between a first and a second end position. Here, the air guiding shells can possibly also assume intermediate positions between the end positions. In particular, precisely two air guiding shells can be provided. They can be of identical configuration and can merely be arranged in a mirror-inverted manner with respect to one another. They can be capable of being moved in the same way, once again, in particular, in a manner which is merely mirror-inverted with respect to one another. The air guiding shells are of shell-shaped configuration. They can be, for example, cylindrical shells. Other curvature geometries are also conceivable, however, for example a conical or parabolic curvature. The curvature geometry can be dependent, in particular, on the opening geometry of the air vent. Thus, for example, conical curvatures can be used in the case of a tapering opening gap. Generally speaking, the air guiding shells can have a constantly curved shape. Here, the concave sides of the at least two air guiding shells face one another. The convex sides of the air guiding shells face opposite inner sides of the housing. The longitudinal axes of the air guiding shells can run, in particular, perpendicularly with respect to the flow direction of the air stream through the housing. In the mounted state in a vehicle, said longitudinal axis can run, for example, in the horizontal direction. The air guiding shells are, in particular, permanently curved. Their shape is therefore not changed for guiding the air stream. If the air guiding shells are moved in the housing between their end positions, the flow duct which is formed by way of them for air which flows through the housing changes. As a result, the air is deflected in a desired way out of its main flow direction. For example, the air stream can be deflected upward or downward by way of a movement of the air guiding shells in the mounted state in a vehicle. The direction and the angle of the air deflection are defined by way of the position and/or movement position and curvature of the air guiding shells, in particular at the outflow point, that is to say the region directly upstream of the outlet opening.

In at least one of their positions, the at least two air guiding shells are situated in a region which is covered by way of the housing outlet wall, as viewed counter to the flow direction of the air stream. They are therefore arranged behind the housing outlet wall as viewed from the vehicle interior compartment, and are concealed by way of said housing outlet wall. As viewed in a direction from the outlet opening to the inlet opening, the air guiding shells are therefore not visible from the vehicle interior compartment. In particular, they are not situated in the flow duct which is formed by way of the cross section of the outlet opening. Said flow duct is therefore not disrupted by way of the air guiding shells. It is thus possible to configure the air guiding shells in such a way that they are perceived as a movable housing wall, but not as air guiding elements which are situated in the flow duct. In particular, the air vent according to the invention can be integrated harmonically into the overall dashboard design of a vehicle as a slot-shaped opening, with the result that the functional elements of the air vents, in particular the air guiding shells, cannot be seen directly from the vehicle interior compartment at least in one position, preferably an end position which can at the same time be a neutral position. Furthermore, the air guiding shells are situated upstream of the outlet opening in every position, in particular, as viewed in the flow direction of the air. Moreover, a particularly homogeneous, swirl-reduced and therefore also noise-reduced flow deflection with at the same time a high possible air deflection angle is made possible by the air guiding shells having a shell-shaped contour. This applies, in particular, in the case of flat, in particular slot-shaped outlet openings. The design freedom of the vent openings within the dashboard overall design is thus maximized. A disruption of the air stream is minimized by way of the arrangement and configuration of the air guiding shells. In particular, the flow duct which is available for the air remains largely open in all movement states of the air guiding shells. The closure of the flow duct, which closure increases with an increasing air deflection in the case of conventional air guiding slats, can be largely avoided according to the invention. In this way, a smaller air pressure drop in the air vent is also achieved. By way of a suitable configuration of the air guiding shells, a funnel effect for the air which flows through and therefore centering of the air stream can be achieved. It is fundamentally also conceivable that the air guiding shells can approach one another during their adjusting movement to such an extent that the outlet opening can be closed by way of them and the air stream into the vehicle interior is therefore prevented. Additional closure elements would then not be required.

As has already been mentioned, the outlet opening of the housing can be of flat, in particular slot-shaped, configuration. The outlet opening can preferably have a length to height ratio of 1.7:1, preferably 2.5:1, further preferably 5:1, further preferably 9:1, further preferably 22:1.

The air guiding shells can be capable of being moved manually between their end positions, for example by way of an operating element. It would also be conceivable, however, that a separate drive, for example an electric motor drive, is provided for the movement of the air guiding shells.

In order to secure the air duct against unauthorized access and/or against unintended pinching of fingers, for example in the case of cleaning and for securing against improper use, the outlet opening can be closed, for example, by way of a grille structure. An outflow grille of this type can be fastened to the housing as a separate component or else can be a single-piece constituent part of the housing or a bezel of the housing. Any desired embodiments of the grille are conceivable, for example as an injection molded grille, a drawn metal grille, a wire grille or a textile grille or the like.

In accordance with one refinement, the at least two air guiding shells can be capable of being moved independently of one another between their end positions. A particularly great flexibility in the case of the air deflection is achieved as a result.

In accordance with a further refinement, the at least two air guiding shells can move in each case in the direction of the inlet opening of the housing, that is to say away from the outlet opening, during their movement from their first end position into their second end position. As a result, the disruption of the air stream in the case of the air deflection is minimized further. In particular, constrictions in the flow course are reduced or avoided in this way. This is the case, in particular, if the air guiding shells are in each case also moved during their adjustment in the direction of the respective other air guiding shell.

The at least two air guiding shells can be covered by way of the housing outlet wall in each case in their first end position. They are then therefore moved out of said first position which is situated behind the housing outlet wall into their second position in order to deflect the air stream, possibly with the assumption of intermediate positions.

It can be provided in accordance with a further refinement that, in the case of at least two air guiding shells which are situated in their first end position, the air stream is not deflected by way of the at least two air guiding shells. In said first end position, the air stream is therefore not deflected in its direction opposite a main flow direction. It exits from the housing into the vehicle interior compartment in its direction which is predefined by way of the connection between the inlet opening and the outlet opening of the housing. For example, the air stream can exit in the horizontal direction into the vehicle interior compartment in the mounted state in a vehicle. The first end position therefore forms a neutral position of the air guiding shells. As has already been mentioned, the air guiding shells can center the air stream in said first end position, in relation to the main flow direction. The second end position can then form a position for a maximum air stream deflection. It goes without saying that intermediate positions are once again also possible between the end positions.

It can be provided in accordance with a further refinement that, in order to deflect the air stream in a first direction, a first one of the at least two air guiding shells is adjusted out of its first end position into its second end position, whereas a second one of the at least two air guiding shells remains in its first end position, and that, in order to deflect the air stream in a second direction, a second one of the at least two air guiding shells is adjusted out of its first end position into its second end position, whereas the first one of the at least two air guiding shells remains in its first end position. The air stream is deflected in the direction of the air guiding shell which remains in the first end position by way of the air guiding shell which is moved into the second end position. Said air guiding shell which remains in the first position is then pressure loaded by way of the deflected air stream. The air stream is then deflected toward the outlet opening by said air guiding shell in a manner which is contingent on its curvature. This can take place, in particular, away from said air guiding shell again. There can be a dead flow area on the air guiding shell which is moved into the second end position. This results in particularly satisfactory focusing and deflecting of the air stream. In the case of a change of the deflection direction of the air, the neutral position of the air guiding shells can always be passed through. As an alternative, it goes without saying that it would also be conceivable that the two air guiding shells are moved at the same time.

For further improved deflecting and focusing, it can be provided that a front end, facing the outlet opening of the at least two air guiding shells, during their movement from their first end position into their second end position, approaches in each case the air guiding shell which remains in its first end position.

In accordance with a further refinement, the front end, facing the outlet opening, of the at least two air guiding shells can be situated closely adjacently with respect to the housing outlet wall in the first end position. In particular, it can be situated directly adjacently with respect to one of the edges of the housing outlet wall which define the outlet opening. It is prevented in this way that air can pass between the air guiding shell and the inner side of the housing outlet wall. This might lead to undesired eddy currents.

It is provided in accordance with a further refinement that in each case a first end of a first coupled air guiding element is connected pivotably to a front end, facing the outlet opening, of the at least two air guiding shells, the first coupled air guiding elements being moved in a coupled manner in the case of a movement of the at least two air guiding shells. The first coupled air guiding elements are connected pivotably to the air guiding shells via the end-side connection. In the case of a movement of the air guiding shells, the respective coupled air guiding element is pulled with them and is therefore likewise moved.

In accordance with a further refinement, in each case at least one second coupled air guiding element can be connected pivotably by way of a first end to a second end of the first coupled air guiding elements, which second end lies opposite the first end. If an air guiding shell is moved between its first and second end position, the corresponding coupled air guiding elements are also moved or pushed. Here, both the air guiding shells and the coupled air guiding elements are guided in corresponding guide curves of the housing. Here, the coupled air guiding elements are arranged in such a way that, in particular in the case of an air guiding shell which is situated in the second end position, the deflected air stream bears against the coupled air guiding elements which are connected to said air guiding shell. By way of the use of what is known as the Coanda effect, an increase in the deflecting angle and a further improved air stream can be achieved. At the same time, the connection, which, in particular, cannot be flowed through by way of air, of the air guiding shells and coupled air guiding elements which are arranged in a linked manner ensures an optimized, laminar, swirl-reduced and therefore also noise-optimized air stream. The pivoting connection between the air guiding shells and the coupled air guiding elements and/or between the coupled air guiding elements can be realized, for example, by way of what are known as two-component shutters, consisting of hard and soft components, textile hinges, or flow-tight connections or the like.

In accordance with a further refinement in this regard for smoothing the air stream, a second end of the second coupled air guiding elements, which second end lies opposite the first end, can be situated in each case closely adjacently with respect to the housing outlet wall in the case of an air guiding shell which is situated in the second end position. In particular, it can be situated directly adjacently with respect to one of the edges of the housing outlet wall which defines the outlet opening. In this way, it is once again prevented that air can pass between the coupled air guiding elements and the inner side of the housing outlet wall, which might otherwise lead to undesired eddy currents.

The housing outlet wall can have a curved shape. Its curvature can be adapted to the curvature of the second coupled air guiding elements. For example, the curvature of the housing outlet wall can be arcuate. The curvature of the housing outlet wall can form a common curved surface together with the front coupled air guiding elements which are closest in the link of the outlet opening, against which common curved surface the flowing air can bear in a further improved manner.

The first and/or second coupled air guiding elements can be coupled air guiding shells, that is to say shell-shaped coupled air guiding elements. These can once again be, for example, cylindrical shells. The concave sides of the coupled air guiding shells can once again face one another in pairs. The longitudinal axes of the coupled air guiding shells can once again run perpendicularly with respect to the flow direction of the air stream through the housing; in the mounted state in a vehicle, they can run in the horizontal direction, for example. The coupled air guiding shells are also permanently curved, in particular, that is to say their shape does not change for guiding the air stream.

It can be provided for the guidance of the air guiding shells and/or the coupled air guiding elements that the at least two air guiding shells and/or the first and/or second coupled air guiding elements are guided in each case via lateral pins in guide grooves of the housing. Each air guiding shell and/or each coupled air guiding element can have at least four lateral pins which lie opposite one another in pairs. The pins can be arranged in each case in the region of the ends of the air guiding shells and/or coupled air guiding elements. This refinement achieves particularly reliable guidance of the movement.

Upstream in the flow direction of the at least two air guiding shells for deflecting the air stream, at least one further air guiding element can be mounted in the housing such that it can be moved between two end positions. The at least one further air guiding element can be at least one air guiding slat which is mounted such that it can be pivoted about a pivot axis between two end positions. The pivot axis can run, for example, in the vertical direction in the mounted state in a vehicle. The at least one air guiding slat can therefore be a vertical slat. A plurality of further air guiding elements, for example air guiding slats, can be provided. They can be coupled to one another in a manner known per se via at least one coupling rod, with the result that they are moved synchronously with respect to one another. The further air guiding elements deflect the air stream, in particular, in a different direction than the air guiding shells, for example in a direction perpendicularly with respect thereto. Whereas the air guiding shells can deflect the air stream, for example, upward and downward in the mounted state in a vehicle, the further air guiding elements can deflect the air stream, for example, in the lateral direction. The further air guiding elements can also be mounted directly in the housing such that they can be pivoted, for example via bearing journals. The movement of the further air guiding elements can take place via manual operating elements, such as operating wheels, push handles or the like, or by way of a separate drive, for example an electric motor drive. This is known per se.

A front side, facing the air guiding shells, of the at least one further air guiding element can have a curved shape. The curvature can be adapted to the curvature of the air guiding shells. The air guiding shells can then be situated closely adjacently with respect to the curved front side of the at least one further air guiding element in their second end position.

The invention also relates to a vehicle, such as a passenger car or a truck, having an air vent according to the invention which is mounted therein.

### BRIEF DESCRIPTION OF THE DRAWINGS

Exemplary embodiments of the invention will be described in greater detail in the following text using figures, in which, diagrammatically:

FIG. 1 shows an air vent according to the invention in a sectional view in accordance with a first exemplary embodiment in a first operating state,

FIG. 2 shows the illustration from FIG. 1 in a second operating state,

FIG. 3 shows the illustration from FIG. 1 in a third operating state,

FIG. 4 shows an air vent according to the invention in a sectional view in accordance with a further exemplary embodiment in a first operating state,

FIG. 5 shows the illustration from FIG. 4 in a second operating state,

FIG. 6 shows the illustration from FIG. 4 in a third operating state, and

FIG. 7 shows a sectional view along the line A-A in FIG. 6.

Unless indicated otherwise, identical designations denote identical objects in the figures.

### DETAILED DESCRIPTION

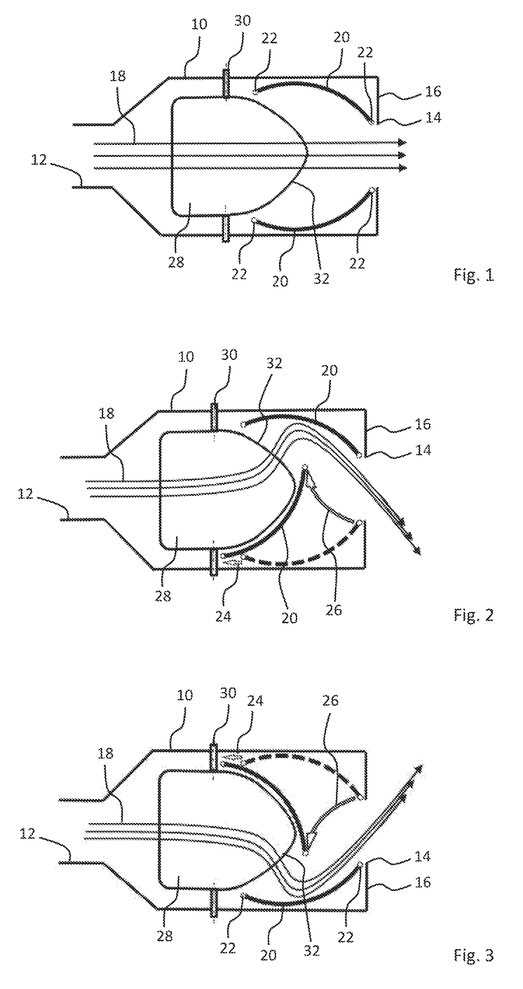

The air vent which is shown in FIG. 1 has a housing 10 with an inlet opening 12 and an outlet opening 14 which is delimited by way of a housing outlet wall 16. An air duct for an air stream 18 which flows along a main flow direction through the housing 10 is defined between the inlet opening 12 and the outlet opening 14. The air vent is installed in a vehicle, such as a passenger car or a truck, and conducts fresh air into the vehicle interior.

In the case of the exemplary embodiment which is shown in FIGS. 1 to 3, two air guiding shells 20 are arranged movably in the housing 10. In the example which is shown, the air guiding shells 20 are curved in each case in a cylindrical shell-shaped manner. FIG. 1 shows a first end position of the air guiding shells 20. In said first end position, the air guiding shells 20 are covered by way of the housing outlet wall 16 as viewed counter to the flow direction of the air, that is to say as viewed from the right to the left in FIG. 1. In the neutral position which is shown in FIG. 1, the air stream is not deflected out of its main flow direction by way of the air guiding shells 20. At their two ends, the air guiding shells 20 which are of identical configuration and are arranged merely in a mirror-inverted manner with respect to one another have two pins 22 which lie opposite one another in each case and are guided in guide grooves (not shown in greater detail) of the housing 10. In this way, the lower air guiding shell 20 can be moved out of the first end position which is shown in FIG. 1 into a second end position which is shown in FIG. 2. The upper air guiding shell 20 in FIG. 1 can correspondingly be moved in this way out of the first end position which is shown in FIG. 1 into a second end position which is shown in FIG. 3. FIGS. 2 and 3 also show the first end positions of the moved air guiding shells 20 using dashed lines for illustrative purposes. As is illustrated in each case using the arrow 24 in FIGS. 2 and 3, moreover, the air guiding shells 20 are moved in each case in the direction of the inlet opening 12 of the housing 10 in the case of the movement into their second end position. As illustrated in each case by way of the arrow 26 in FIGS. 2 and 3, the front end of the air guiding shells 20, which front end in each case faces the outlet opening 14 and is the right hand end in the figures, approaches, in the case of its movement into the second end position, in each case the other air guiding shell 20 which remains in its first end position. It can be seen in FIGS. 1 to 3, furthermore, that the front end of the air guiding shells 20 which faces the outlet opening 14 is situated closely adjacently with respect to the housing outlet wall 16 in the first end position.

By way of the adjustability of the air guiding shells 20 between their first and second end position, the air stream 18 can be deflected out of its main flow direction which is shown in FIG. 1, in FIGS. 1 to 3 downward (FIG. 2) or upward (FIG. 3). This is achieved by way of the shape and position of the air guiding shells 20. The air guiding shell 20 which is moved in each case into its second end position in FIGS. 2 and 3 thus deflects the air stream 18 in the direction of the air guiding shell 20 which remains in the first end position, with the result that the latter is pressure loaded by way of the air stream 18. On account of its curvature, the air guiding shell 20 which remains in the first end position then guides the air stream away from it again in a manner which corresponds to its curvature, downward in FIG. 2 and upward in FIG. 3.

In FIGS. 1 to 3, moreover, one of a plurality of air guiding slats which are arranged parallel to one another and are mounted on the housing 10 such that they can be pivoted about a pivot axis 30 are shown at the designation 28. It goes without saying that it would also be conceivable to provide only one air guiding slat of this type. The air guiding slat 28 which can be seen in FIGS. 1 to 3 is coupled to the remaining air guiding slats 28 which are arranged behind it and in front of it in the plane of the drawing, for example via at least one coupling rod, with the result that they pivot synchronously. Pivoting of the air guiding slats 28 about the pivot axis 30 correspondingly leads to a lateral deflection of the air stream 18. This is known per se.

Moreover, it can also be seen in FIGS. 1 to 3 that the front side 32 of the air guiding slat 28, which front side 32 faces the outlet opening 14, (and the remaining air guiding slats being of identical configuration) has a curved shape which is adapted to the curvature of the air guiding shells 20. As can be seen in FIGS. 2 and 3, in particular, the air guiding shells 20 are situated closely adjacently with respect to said front side 32 in their second end position.

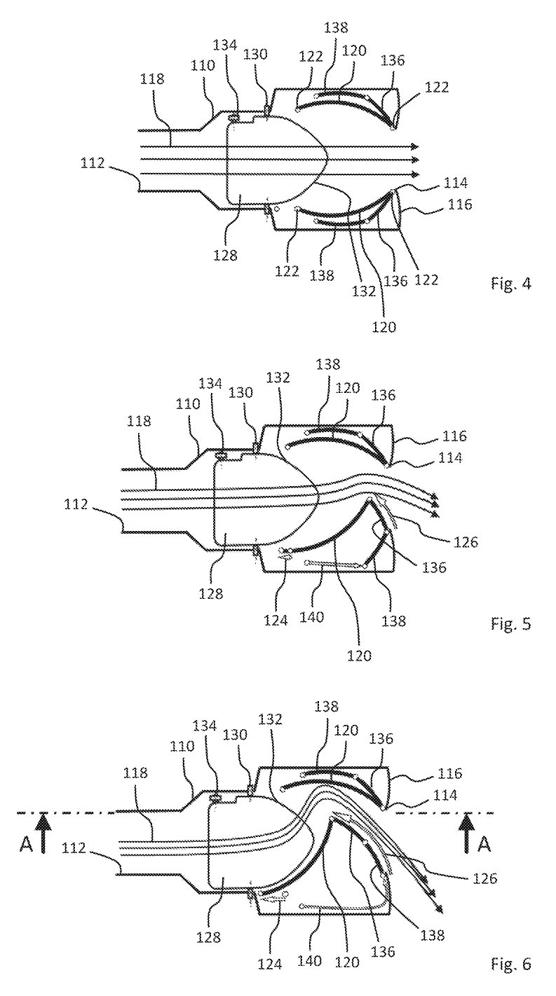

The exemplary embodiment which is shown in FIGS. 4 to 6 corresponds largely to the exemplary embodiment from FIGS. 1 to 3. The air vent which is shown in FIGS. 4 to 6 also has a housing 110 with an inlet opening 112 and an outlet opening 114 which is delimited by way of a housing outlet wall 116 for an air stream 118. Air guiding shells 120 are once again mounted in the housing 110 such that they can be moved between a first end position which is shown in FIG. 4 and a second end position which is shown in FIG. 6 for the lower air guiding shell 120 in the figures. It is to be noted that FIGS. 5 and 6 show only the movement of the lower air guiding shell 120. The movement of the upper air guiding shell 120 takes place in an identical, merely mirror-inverted way.

The air guiding shells 120 once again have the pins 122 which have already been described with respect to FIGS. 1 to 3 at their ends, which pins 122 are guided in corresponding guide grooves of the housing 110. It can be seen in the intermediate position which is shown in FIG. 5 between the first end position (FIG. 4) and the second end position (FIG. 6) and in the second end position which is shown in FIG. 6, once again illustrated by way of arrows 124, that the air guiding shells 120 are moved in each case in the direction of the inlet opening 112 in the case of their movement into the second end position. Moreover, it is illustrated in FIGS. 5 and 6 by way of the arrows 126 that the front end of the air guiding shells 120 which faces the outlet opening 114 approaches the air guiding shell 120 which remains in the first end position in the case of their movement into the second end position. By way of adjustment of the air guiding shells 120 into the second end position, the air stream 118 can be deflected from its main flow direction, as shown in FIGS. 5 and 6 by way of example for a deflection downward. In a corresponding way, a deflection of the air stream 118 upward can take place by way of movement of the upper air guiding shell 120 into its second end position.

In FIGS. 4 and 6, air guiding slats 128 are once again mounted on the housing 110 upstream of the air guiding shells 120 such that they can be pivoted about a pivot axis 130. By way of pivoting of the air guiding slats 128 about their pivot axes 130, as described above with respect to FIGS. 1 to 3, the air stream 118 can be deflected in the lateral direction. Moreover, FIGS. 4 to 6 also show a coupling rod which couples the air guiding slats 128 for synchronous pivoting at the designation 134. The air slats 128 of FIGS. 4 to 6 also have a curved front edge 132, as described above with respect to FIGS. 1 to 3.

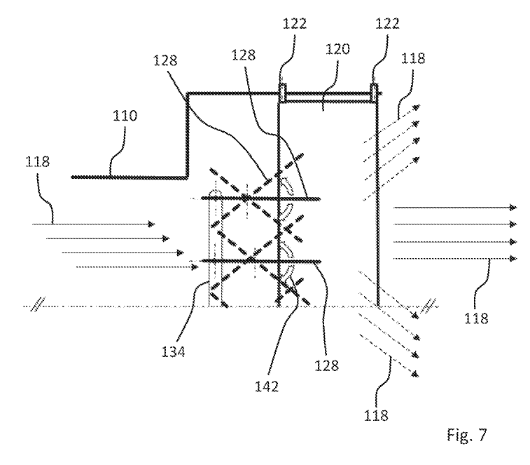

The sectional view of FIG. 7 shows the adjustment of the air guiding slats 128, the adjusted positions of the air guiding slats 128 being shown using dashed lines. The deflection, contingent thereon, of the air stream 118 in the lateral direction is likewise shown using dashed lines. The movement of the air guiding slats 128 is illustrated by way of arrows 142.

In contrast to the exemplary embodiment which is shown in FIGS. 1 to 3, first coupled air guiding elements 136 and second coupled air guiding elements 138 which are coupled to the air guiding shells 120 are provided, moreover, in the case of the exemplary embodiment of FIGS. 4 to 6. The first and second coupled air guiding elements 136, 138 are coupled pivotably in a link arrangement to the respective front ends of the air guiding shells 120 and to one another. In the case of a movement of the air guiding shells 120 between the first end position and the second end position, the coupled air guiding elements 136, 138 are also moved or pushed, as shown by way of example from a comparison of FIGS. 4 to 6 for the lower air guiding shell 120 and the lower coupled air guiding elements 136, 138. For the upper air guiding shell 120 and the upper coupled air guiding elements 136, 138, said movement takes place in a corresponding way. The coupled air guiding elements 136, 138 are likewise of shell-shaped configuration. In the region of their ends, they likewise have guide pins which lie opposite one another in each case in pairs and are guided in corresponding guide grooves of the housing 110. The movement of the coupled air guiding elements 136, 138 is illustrated in FIGS. 5 and 6 by way of the arrows 140. As can be seen in FIG. 6, in particular, the coupled air guiding elements 136, 138 form a contiguous curved surface in the second end position of the air guiding shells 120 together with the housing outlet wall 116 which is of curved configuration in this case, against which contiguous curved surface the air stream 118 bears in a particularly effective way.

### LIST OF DESIGNATIONS

10 Housing

12 Inlet opening

14 Outlet opening

16 Housing outlet wall

18 Air stream

20 Air guiding shells

22 Guide pin

24 Arrow

26 Arrow

28 Air guiding slats

30 Pivot axis

32 Front side

110 Housing

112 Inlet opening

114 Outlet opening

116 Housing outlet wall

118 Air stream

120 Air guiding shells

122 Pin

124 Arrow

126 Arrow

128 Air guiding slats

130 Pivot axis

132 Front edge

134 Coupling rod

136 Coupled air guiding elements

138 Coupled air guiding elements

140 Arrow

142 Arrow

What is claimed is:

1. An air vent for a vehicle, comprising:
a housing (10, 110) with an inlet opening (12, 112) and an outlet opening (14, 114), the outlet opening delimited by way of a housing outlet wall (16, 116), wherein an air duct for an air stream (18, 118) is defined between the inlet opening (12, 112) and the outlet opening (14, 114) to permit flow of the air stream in a flow direction from the inlet opening (12, 112) to the outlet opening (14, 114);
air guiding elements arranged adjustably in the housing (10, 110) for deflecting the air stream (18, 118), wherein the air guiding elements comprise at least two air guiding shells (20, 120) which are mounted in the housing (10, 110) such that each one of the at least two air guiding shells can be moved between a first end position and a second end position in order to deflect the air stream (18, 118), each one of the at least two air guiding shells (20, 120) being covered by way of the housing outlet wall (16, 116) at least in one position, as viewed counter to the flow direction of the air stream (18, 118).

2. The air vent as claimed in claim 1, wherein each one of the at least two air guiding shells (20, 120) can be moved independently of the other one of the two air guiding shells between the first and second end positions.

3. The air vent as claimed in claim 1, wherein each one of the at least two air guiding shells (20, 120) moves in in a direction toward the inlet opening (12, 112) of the housing (10, 110) during movement from the first end position into the second end position.

4. The air vent as claimed in as claimed in claim 1, wherein each one of the at least two air guiding shells (20, 120) is covered by way of the housing outlet wall (16, 116) in when in the first end position.

5. The air vent as claimed in claim 4, wherein, in the case of each one of the at least two air guiding shells (20, 120), the air stream (18, 118) is not deflected when the air guiding shell is in the first end position.

6. The air vent as claimed claim 5, wherein, in order to deflect the air stream (18, 118) in a first direction, a first one of the at least two air guiding shells (20, 120) is adjusted out of its first end position into its second end position, whereas a second one of the at least two air guiding shells (20, 120) remains in its first end position, and wherein, in order to deflect the air stream (18, 118) in a second direction, a second one of the at least two air guiding shells (20, 120) is adjusted out of its first end position into its second end position, whereas the first one of the at least two air guiding shells (20, 120) remains in its first end position.

7. The air vent as claimed in claim 6, wherein a front end of each one of the at least two air guiding shells (20, 120) faces the outlet opening, and during movement from the first end position into the second end position, the front end approaches the other one of the at least two air guiding shells (20, 120) that remains in its first end position.

8. The air vent as claimed in claim 7, wherein each front end is situated closely adjacent to the housing outlet wall (16, 116) when in the first end position.

9. The air vent as claimed in claim 1, wherein a front end of each of the at least two air guiding shells is pivotably connected to a first end of a respective first coupled air guiding element (136), each front end facing the outlet opening (14, 114), each of the first coupled air guiding elements (136) being moved in a coupled manner in the case of a movement of its connected air guiding shell (20, 120).

10. The air vent as claimed in claim 9, wherein each first coupled air guiding element (136) has a second end, opposite the first end, and pivotably connected to a first end of a respective second coupled air guiding element (138).

11. The air vent as claimed in claim 10, wherein each second coupled air guiding elements (138) has a second end, opposite its first end, wherein the second is situated closely adjacent to the housing outlet wall (16, 116) when the air guiding shell (20, 120) to which the second coupled air guiding element is indirectly connect is situated in the second end position.

12. The air vent as claimed in claim 10, wherein each of the first coupled air guiding elements (136) is in the form of an air guiding shell and each of the second coupled air guiding elements (138) is in the form of an air guiding shells.

13. The air vent as claimed in claim 1, wherein each one of the at least two air guiding shells (20, 120) is guided in movement via lateral pins (22, 122) in guide grooves of the housing (10, 110).

14. The air vent as claimed in claim 1, wherein, upstream in the flow direction of the at least two air guiding shells (20, 120), at least one further air guiding element is mounted in the housing (10, 110) such that it can be moved between two end positions.

15. The air vent as claimed in claim 14, wherein the at least one further air guiding element is at least one air guiding slat (28, 128) which is mounted such that the air guiding slat can be pivoted about a pivot axis (30, 130) between two end positions.

16. An air vent for a vehicle, comprising:
a housing (10, 110) with an inlet opening (12, 112) and an outlet opening (14, 114), the outlet opening delimited by way of a housing outlet wall (16, 116), wherein an air duct for an air stream (18, 118) is defined within the housing between the inlet opening (12, 112) and the outlet opening (14, 114) to permit flow of the air stream in a flow direction from the inlet opening (12, 112) to the outlet opening (14, 114);
first and second air guiding elements arranged adjustably in the housing (10, 110) for deflecting the air stream (18, 118), wherein the first air guiding element comprises a first air guiding shell (20, 120) and the second air guiding element comprises a second air guiding shell (20,120), the first air guiding shell mounted in the housing (10, 110) for movement between a first end position and a second end position in order to deflect the air stream (18, 118), the second air guiding shell mounted in the housing (10, 110) for movement between a first end position and a second end position in order to deflect the air stream (18, 118), the first air guiding shell covered, as viewed counter to the flow direction, by way of the housing outlet wall (16, 116) when in at least one position, the second air guiding shell covered, as viewed counter to the flow direction, by way of the housing outlet wall (16, 116) when in at least one position.

17. The air vent as claimed in claim 16, wherein:
the first air guiding shell can be moved independently of the second air guiding shell and the second air guiding shell can be moved independently of the first air guiding shell;
the first air guiding shell moves in in a direction toward the inlet opening (12, 112) of the housing (10, 110) during movement from its first end position into its second end position, and the second air guiding shell moves in in a direction toward the inlet opening (12, 112) of the housing (10, 110) during movement from its first end position into its second end position;

18. The air vent as claimed in claim 16, wherein:
the first air guiding shell includes a front end, which faces the outlet opening, and which is pivotably connected to a first end of a first coupled air guiding element (136), wherein the first coupled air guiding element (136) moves in a coupled manner with the first air guiding shell;
the second air guiding shell includes a front end, which faces the outlet opening, and which is pivotably connected to a first end of a second coupled air guiding element (136), wherein the second coupled air guiding element (136) moves in a coupled manner with the second air guiding shell.
